(19) United States
(12) Patent Application Publication
(10) Pub. No.: US 2006/0068766 A1
(43) Pub. Date: Mar. 30, 2006

(54) Communication device with operational response capability and method therefor

(76) Inventors: Min Xu, Vernon Hills, IL (US); Minghui Liu, Hoffman Estates, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/941,519

(22) Filed: Sep. 15, 2004

(51) Int. Cl. H04Q 7/38

(52) U.S. Cl. 455/414.1

(57) ABSTRACT

A communication device 200 includes a memory 220, a transceiver 210, and a communication processor 215 coupled between. The memory 220 stores at least one device operation 310 associated with each of at least one linguistic term 305. The transceiver 210 is capable of receiving a communication. The communication processor 215 is adapted to compare at least one portion of the communication with each of the at least one linguistic term; and implement the at least one device operation in response to a match between the at least one portion of the communication and at least one stored linguistic term.

### BACKGROUND OF THE INVENTION

1. Field of the Invention

The present invention is generally related to communication devices and in particular to communication devices having text, graphics, and multimedia messaging capability.

2. Description of the Related Art

As technology increases, people are having more and more interactions using many different communication devices. When communicating remotely, such as when participating in a telephone call, since the participants can not see, or feel each other, the degree of communication is limited to the words and/or text itself.

One prior art technique allows a participant to send emotional information as part of a communication. However, this technique requires an active input of information by the sender and compatible capabilities by the recipient. For example, the sender can utilize an emoticon within a data message being transmitted. Short for emotion icon, an emoticon is a small icon composed of keyboard characters and used in text messaging that indicates the mood and/or emotion of the writer. Because of the nature of written text, which doesn't rely on vocal inflection and facial cues to communicate attitudes such as sarcasm and humor, the writer's tone is often not apparent. Emoticons, when read sideways, mimic facial expressions and therefore relay the emotion behind an expression. Emoticons are used in e-mail, chat, SMS and other forms of communication. The most popular emoticons are the smiling faces that people use to say “don't take what I just wrote too seriously”. The colon represents the eyes, the dash represents the nose, and the right parenthesis represents the mouth. In some messaging applications, when using emoticons, they will be converted to real icons prior to sending the communication. These emoticons show an Emotion through an ‘Icon’.

One drawback to the prior art techniques is the reliance on the sender to provide the emotional intent. Further, the prior art techniques do not allow for customization by the recipient of the expression of emotion.

Many of today's communication devices include multimedia capabilities. For instance, some communication devices can store video clips, including music, images, and human voice. Some communication devices can store a variety of ring tone alerts. Some communication devices can also store music using Musical Instrument Digital Interface (MIDI) files. Once stored, the multimedia files are available for use by a variety of features and functions within each device.

### BRIEF DESCRIPTION OF THE DRAWINGS

The accompanying figures, where like reference numerals refer to identical or functionally similar elements throughout the separate views and which together with the detailed description below, are incorporated in and form part of the specification, serve to further illustrate various embodiments and to explain various principles and advantages all in accordance with the present invention.

FIG. 1 is a block diagram illustrating a simplified and representative example of a communication system.

FIG. 2 is a block diagram illustrating portions of an exemplary communication device for use within the communication system of FIG. 1.

FIG. 3 illustrates one exemplary embodiment of a memory for storage of emotional word associations for use within the communication device of FIG. 2.

FIG. 4 is a flow chart illustrating an exemplary procedure for detecting a communication and associating the communication with a device response.

### DETAILED DESCRIPTION

The present invention relates to an apparatus, method and system for providing emotional enhancement of remote communications by detecting various emotional verbal and textual words and phrases and causing the respective communication device to respond accordingly. Such associated responses can be stored in the recipient device autonomously and accessed in real time by any receiver of a communication.

Advantageously, the present invention provide a mechanism to capture, characterize, interpret various key words and phrases received by a recipient device to provide further context during the communication, enabling the recipient communication device to adapt his communication accordingly. The present invention enables superior dialogue with or without the physical presence of the communicating parties, by providing a classification of emotions and the like.

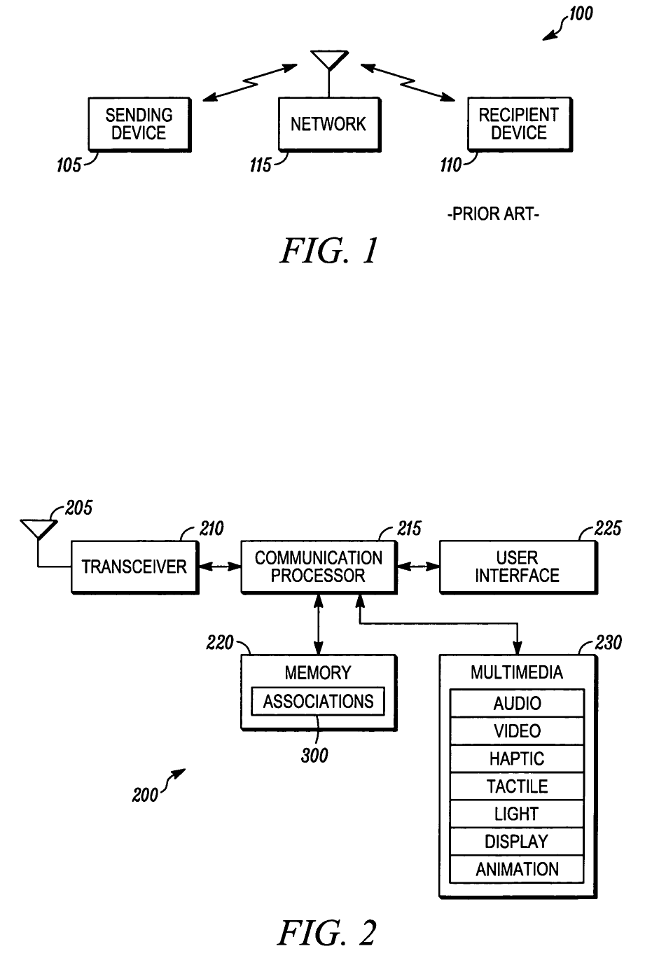

FIG. 1 is a block diagram illustrating a simplified and representative example of a communication system 100 including at least two communication devices capable of communicating together. The communication devices, as illustrated, include at least one sending device 105 and at least one recipient device 110. It will be appreciated by those of ordinary skill in the art, that more than two devices are typically included within the communication system 100. In the context of the present invention, communication device 110 will be referred to as the recipient device 110 communication device 105 will be referred to as a sending device 105. However, it should be recognized that these roles easily can be reversed such that the present invention operates in a two-way mode. In particular, a device can act as both a sender and recipient device at the same time. For simplification, the mechanism and method of the present invention will be described with reference to each of the sender device 105 and the recipient device 110 at a fixed moment in time.

It will be appreciated that each of the communication devices, including the sender device 105 and the recipient device 110 can be a cellular telephone, a mobile device, a two-way messaging device, a cordless telephone, a corded telephone, a personal computer, a personal digital assistant, or any other type of communication device. The communication device is capable of communication with any other communication device and associated user through an existing or future network interface 115, including direct point-to-point connection. For example, the communication can be transmitted over a cellular digital packet data (CDPD) or short message service (SMS) on an existing analog advanced mobile phone (AMPS) service or over point-to-point and push-to-talk services. The communication can also be transmitted in a data format of the Global System for Mobile communications (GSM) system or a time division multiple access (TDMA) system or code division multiple access (CDMA) system. A worldwide satellite network, Internet network, wide area network, and local area network can also be used for the network 115.

In operation, the present invention describes a system wherein the sending device 105 sends (i.e. transmits) an outgoing communication via the network 115 to the recipient device 110. The recipient device 110 is capable of relating predetermined received linguistic terms (for example: written word, a written phrase, a spoken word, or a spoken phrase) to a device operation such as a device response or event within the recipient device. The devices communicate over the network 115 using one or more communication protocols.

FIG. 2 is a block diagram illustrating portions of an exemplary communication device 200 for use within the communication system 100 of FIG. 1. Specifically, the block diagram of FIG. 2 illustrates portions of the recipient device 110 of FIG. 1. The communication device 200, by way of example only, can be embodied in a cellular radiotelephone having a conventional cellular radio transceiver circuitry, as is known in the art, and will not be presented here for simplicity. The invention is alternatively applied to other communication devices such as, for example, messaging devices, personal digital assistants and personal computers with communication capability, mobile radio handsets, cordless radiotelephone and the like.

The communication device 200 includes conventional device hardware (also not represented for simplicity) such as user interfaces, displays, and the like, that are integrated in a compact housing. Each particular communication device will offer opportunities for implementing the present invention.

As illustrated in FIG. 2, the communication device 200 includes an antenna 205, a transceiver 210, a communication processor 215, a memory 220, a user interface 225, and one or more multimedia 230.

The antenna 205 intercepts transmitted signals from one or more communication networks and transmits signals to the one or more communication networks. The antenna 205 is coupled to the transceiver 210, which employs conventional demodulation techniques for receiving the communication signals. The transceiver 210 is coupled to the communication processor 215 and is responsive to commands from the communication processor 215. When the transceiver 210 receives a command from the communication processor 215, the transceiver 210 sends a signal via the antenna 205 to one or more communication systems. In this manner, the antenna 205 and the transceiver 210 are utilized by the communication device 200 to operate in various communication operating modes.

In an alternative embodiment (not shown), the communication device 200 includes a receive antenna and a receiver for receiving signals from one or more of the communication systems and a transmit antenna and a transmitter for transmitting signals to one or more of the communication systems. It will be appreciated by one of ordinary skill in the art that other similar electronic block diagrams of the same or alternate type can be utilized for the communication device 200.

It will be appreciated by one of ordinary skill in the art that the antenna 205 and transceiver 210 are adapted to communicate within various communication systems in accordance with at least one of several standards. These standards include analog, digital or dual-mode communication system protocols such as, but not limited to, the Advanced Mobile Phone System (AMPS), the Narrowband Advanced Mobile Phone System (NAMPS), the Global System for Mobile Communications (GSM), the IS-136 Time Division Multiple Access (TDMA) digital cellular system, the IS-95 Code Division Multiple Access (CDMA) digital cellular system, the CDMA 2000 system, the Wideband CDMA (W-CDMA) system, the Personal Communications System (PCS), the Third Generation (3G) system, the Universal Mobile Telecommunications System (UMTS) and variations and evolutions of these protocols. In the following description, the term “communication system” refers to any of the systems mentioned above or an equivalent. Additionally, it is envisioned that communication systems can include wireless local area networks, including pico-networks, or the like.

Coupled to the transceiver 210, is the communication processor 215 utilizing conventional signal-processing techniques for processing received communications including voice or text messages, voice calls, video images, and the like. It will be appreciated by one of ordinary skill in the art that additional processors can be utilized as required to handle the processing requirements of the communication processor 215. The communication processor 215 decodes an identification in the demodulated data of a received message and/or voice communication, compares the decoded identification with one or more identifications stored in the memory 220, and when a match is detected, proceeds to process the remaining portion of the received message and/or voice communication. The one or more identifications, for example, can be a unique selective call address assigned within a wireless communication system, an electronic mail address, an IP (intemet protocol) address or any other similar identification.

The communication processor 215, as illustrated, is coupled to one or more multimedia 230. Upon receipt and processing of a message or a call, the communication processor 215 preferably generates a command signal to the one or more multimedia 230 as a notification that the message has been received and stored or alternatively that a call is waiting for a response. The one or more multimedia 230 similarly can be utilized for other alerting notifications such as an alarm clock, a calendar event alert, an alert notification that a communication call has been disconnected or has failed, and the like. The one or more multimedia 230 can include a speaker with associated speaker drive circuitry capable of playing melodies and other audio, a vibrator with associated vibrator drive circuitry capable of producing a physical vibration, or one or more light emitting diodes (LEDs) with associated LED drive circuitry capable of producing a visual alert, as well as other multimedia capabilities such as video, haptic, tactile, and animation alerts. It will be appreciated by one of ordinary skill in the art that other similar alerting means as well as any combination of the audible, vibratory, and visual alert outputs herein described can be used.

To perform the necessary functions of the communication device 200, the communication processor 215 is operatively coupled to the memory 220, which can include a random access memory (RAM), a read-only memory (ROM), an electrically erasable programmable read-only memory (EEPROM), and flash memory. The memory 220, for example, includes memory locations for the storage of one or more received or transmitted messages, one or more software applications, one or more media data, and the like. It will be appreciated by those of ordinary skill in the art that the memory 220 can be integrated within the communication device 200, or alternatively, can be at least partially contained within an external memory such as a memory storage device. The memory storage device, for example, can be a subscriber identification module (SIM) card. A SIM card is an electronic device typically including a microprocessor unit and a memory suitable for encapsulating within a small flexible plastic card. The SIM card additionally includes some form of interface for communicating with the communication device 200. The SIM card can be used to transfer a variety of information from/to the communication device 200 and/or any other compatible device.

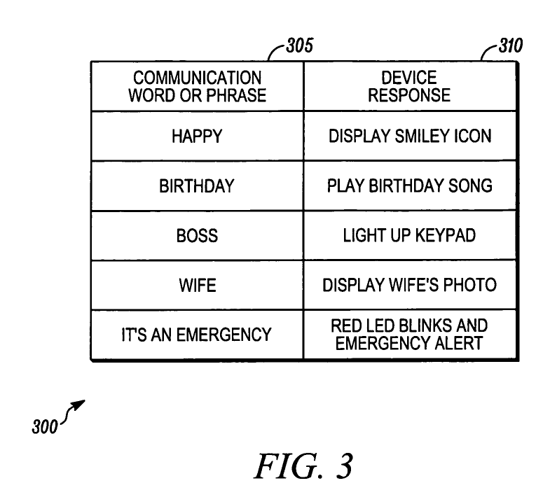

The memory 220, in accordance with one embodiment of the present invention, includes an associations memory 300. One exemplary embodiment of the associations memory 300 is illustrated in FIG. 3. The associations memory 300 stores various predetermined linguistic terms (i.e. words and phrases) 305 and associated device operation responses 310. Each operation response 310 is triggered (i.e. activated) when the associated linguistic term (either verbal or textual) is received from a sending device during a communication. As illustrated in FIG. 3, each communication word or phrase can represent emotions such as “happy”, “sad”, “love”, etc. The associated operation responses 310 can include one or more of the multimedia 230 such as sound, voice, video image, and the like. The associations memory 300 can comprise a default set of associations stored at the time of manufacture of the communication device 200 or can be revised by a user or downloaded by the user using techniques well known in the art. As an example, various entries of associated words/phrases and operation response can be updated by the user by downloading Java contents from the World Wide Web.

Referring back to FIG. 2, the user interface 225 is coupled to the communication processor 215 or alternatively directly to the memory 220 (not shown). The user interface 225 can be one or more buttons or selections used to generate a button press, a series of button presses, a voice response from the device user, or some other similar method of manual response initiated by the device user of the communication device 200. The user interface 225, for example, can be used to store new entries within the associations memory 300.

The communication processor 215 preferably is programmed to monitor received communications and compare the received communications to the associations memory 220 and respond accordingly. Alternatively, the associations operation can be coupled to the communication processor 215 as a separate module. The functionality can be hard coded or programmed into the communication device 200 during manufacturing, can be programmed over-the-air upon customer subscription, or can be a downloadable application. It will be appreciated that other programming methods can be utilized for programming the functionality of the present invention into the communication device 200. It will be further appreciated by one of ordinary skill in the art that the functionality of the present invention can be implemented within hardware circuitry within the communication device 200.

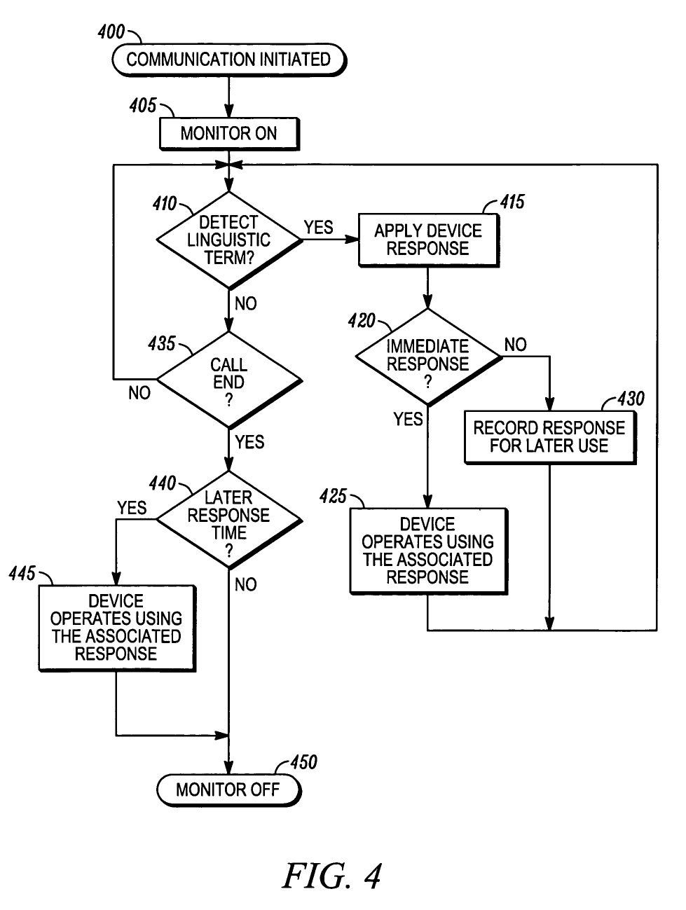

FIG. 4 is a flow chart illustrating an exemplary procedure for detecting a communication and associating the communication with a device response. Specifically, FIG. 4 illustrates one exemplary embodiment of the operation of the communication processor 215 in utilizing the information stored in the associations memory 300 to enhance the communications experience when a device user is participating in a communication session.

As illustrated in FIG. 4, the operation begins with Step 400 in which a communication is initiated with the recipient device 110. It will be appreciated that the recipient device 110 can initiate a communication, such as a voice call or text messaging session, with the sending device 105; or alternatively the sending device 105 can initiate a communication with the recipient device 105. Next, in Step 405, a communication monitor is activated. For example, upon initiation of the communication, the communication device can automatically start an internal “monitor engine”, which will monitor the communication (speech or text) continuously. The monitor engine, for example, can be within the communication processor 215 as described previously herein.

Next, in Step 410, the monitor engine compares each linguistic term (i.e. words and phrases) within the received communication to the associations memory 300 in order to identify utilized stored linguistic terms (i.e. words and/or phrases). When a match is detected in Step 410, the operation continues to Step 415 in which it applies the associated device response. Next, in Step 420, the operation determines whether an immediate response is desired. When an immediate response is desired, the operation continues to Step 425 in which the device operates using the associated response. The associated response, for example, can include activating one or more media such as sound, voice, image, animation, vibration, light, tactile, haptics, or any combination thereof. When an immediate response is not desired in Step 420, the response is recorded for later use in Step 430.

After the response is recorded for later use in Step 430 or the response is operated in Step 425, the operation cycles back to Step 410 to continue to monitor for a detection of a stored key word or phrase.

Returning to the operation of Step 410, when no stored linguistic term (i.e. key word or phrase) is detected, the operation continues to Step 435 and determines whether or not the communication has been terminated. When the communication has not been terminated, the operation cycles back to Step 410 and continues to monitor the contents of the communication. When the communication has been terminated in Step 435, the operation continues to Step 440 to determine whether a later response time has been reached. When a later response time is indicated in Step 440, the device operates using the previously recorded response in Step 445. The associated response, for example, can include activating one or more media such as sound, voice, image, animation, vibration, light, tactile, haptics, or any combination thereof. When no later response is identified in Step 440, the monitor operation is turned off in Step 450.

The present invention as described herein provides a mechanism and method to help people talking on a telephone or communicating via text messaging feel each other's emotion better, and give them new excitement each time they are talking by automatically detecting the emotional words in their telephone conversation or text messages, and, having the communication device respond accordingly.

While this disclosure includes what are considered presently to be the preferred embodiments and best modes of the invention described in a manner that establishes possession thereof by the inventors and that enables those of ordinary skill in the art to make and use the invention, it will be understood and appreciated that there are many equivalents to the preferred embodiments disclosed herein and that modifications and variations may be made without departing from the scope and spirit of the invention, which are to be limited not by the preferred embodiments but by the appended claims, including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software, if any, will be limited in the interest of brevity and minimization of any risk of obscuring the principles and concepts according to the present invention.

We claim:

1. A method of communication enhancement within a communication device, comprising the steps of:
associating at least one device operation with each of at least one linguistic term;
receiving a communication;
comparing at least one portion of the communication with the at least one linguistic term; and
implementing the at least one device operation when a match is detecting in the comparing step.

2. The method of communication enhancement as recited in claim 1, further comprising the step of:
delaying the implementing step until a later response time.

3. The method of communication enhancement as recited in claim 1, wherein the associating step comprises:
storing a plurality of linguistic terms and associated device operations.

4. The method of communication enhancement as recited in claim 3, wherein the storing step comprises:
receiving one or more user inputs including instructions for associating each of the plurality of linguistic terms with one or more device operations.

5. The method of communication enhancement as recited in claim 1, wherein the at least one device operation is selected from a group comprising sound, voice, image, animation, vibration, light, tactile, and haptics.

6. The method of communication enhancement as recited in claim 1, wherein the at least one linguistic term is selected from a group comprising a written word, a written phrase, a spoken word, and a spoken phrase.

7. A method of communication enhancement comprising:
associating at least one device operation with at least one linguistic term by a first device;
transmitting a communication from a second device to the first device; and
activating the at least one device operation within the first device in response to receiving the communication when the communication includes the at least one linguistic term.

8. The method of communication enhancement as recited in claim 7, wherein the associating step comprises:
storing a plurality of linguistic terms and associated device operations within the first device.

9. The method of communication enhancement as recited in claim 8, wherein the storing step comprises:
receiving one or more user inputs including instructions for associating each of the plurality of linguistic terms with one or more device operations.

10. The method of communication enhancement as recited in claim 7, wherein the at least one device operation is selected from a group comprising sound, voice, image, animation, vibration, light, tactile, and haptics.

11. The method of communication enhancement as recited in claim 7, wherein the at least one linguistic term is selected from a group comprising a written word, a written phrase, a spoken word, and a spoken phrase.

12. A communication device comprising:
a memory for storing at least one device operation associated with each of at least one linguistic term;
a transceiver for participating within a communication;
a communication processor coupled between the transceiver and the memory, the communication processor adapted to:
compare at least one portion of the communication with each of the at least one word; and
implementing the at least one device operation in response to a match between the at least one portion of the communication and at least one stored word.

13. The communication device as recited in claim 12 wherein the communication processor is further adapted to:
delay the implementing of the at least one device operation to a later response time.

14. A communication system comprising:
a first device for transmitting a communication to a second device; and
the second device, comprising:
a memory for storing at least one linguistic term and at least one associated device operation;
a transceiver for receiving the communication from the first device; and
a processor for activating the at least one device operation within the first device in response to receiving the communication when the communication includes the at least one linguistic term.

15. The communication system as recited in claim 14, wherein the second device further comprises:
a user interface for receiving one or more user inputs including instructions for associating each of the plurality of linguistic terms with one or more device operations.

16. The communication system as recited in claim 14, wherein the at least one device operation is selected from a group comprising sound, voice, image, animation, vibration, light, tactile, and haptics.

17. The communication system as recited in claim 14, wherein the at least one linguistic term is selected from a group comprising a written word, a written phrase, a spoken word, and a spoken phrase.
